(19) United States
(12) Patent Application Publication
(10) Pub. No.: US 2025/0065825 A1
(43) Pub. Date: Feb. 27, 2025

(54) RECREATIONAL VEHICLE AND EQUIPMENT FOR A RECREATIONAL VEHICLE

(71) Applicant: Thor Tech, Inc., Elkhart, IN (US)

(72) Inventors: Marcus Metzler, Bad Waldsee (DE); Rainer Buck, Wangen (DE); Gunter Dorn, Schlier (DE)

(73) Assignee: Thor Tech, Inc., Elkhart, IN (US)

(21) Appl. No.: 18/813,767

(22) Filed: Aug. 23, 2024

(30) Foreign Application Priority Data
Aug. 27, 2023 (DE) 10 2023 123 011.5

(51) Int. Cl. B60R 15/04; B60R 15/02

(52) U.S. Cl. CPC B60R 15/04; B60R 15/02

(57) ABSTRACT

A piece of furnishing for a recreational vehicle, in particular for a mobile home or a caravan or for a van serving as a recreational vehicle, comprises a body, a toilet and a sink, which is designed in particular as a restroom sink and/or kitchen sink. The toilet and the restroom sink are attached to the body. In a basic position the toilet is arranged below the sink. Furthermore, a recreational vehicle with such a piece of furnishing is specified.

The invention relates to a recreational vehicle, in particular a mobile home or a caravan, and a piece of furnishing for such a recreational vehicle.

In particular, the invention relates to the field of furnishing which are installed in an interior, in particular living space, of such a recreational vehicle.

A recreational vehicle designed as a campervan is known from CA 2368938 A1. A piece of kitchen furnishing is arranged in the rear part of the campervan. The piece of kitchen furnishing is provided in a functional region. A restroom is provided in another functional region. This other functional region is for personal hygiene and can also be used for a shower. The kitchen may have a kitchen sink.

The layout of the recreational vehicle known from CA 2368938 A1 has the disadvantage that the space required for the furnishing is large. Due to the relatively small dimensions of the interior of the campervan, there is only little space available for a functional region in the front region of the vehicle, which includes the driver's seats. To sleep, this functional region must then be converted, including the driver's seats. This requires a significant additional effort on the part of the vehicle design. In addition, campervans may be too small to accommodate all three functional regions. The scope of application of this well-known floor plan division is therefore limited.

The object of the invention is to provide a piece of furnishing for a recreational vehicle and a recreational vehicle which have an improved design and/or allow for improved use. In particular, it is an object of the invention to provide a piece of furnishing for a recreational vehicle and a recreational vehicle which are improved in such a way that, if necessary, even without standing height and in very small spaces, in particular interior spaces, provisions for both personal hygiene and for preparing food are possible.

The object is achieved by a piece of furnishing with the features of independent claim 1 and by a recreational vehicle with the features of claim 10. Advantageous further developments of the invention are given in the dependent claims.

The object is achieved by a piece of furnishing for a recreational vehicle, in particular for a mobile home or a caravan or for a van designed as a recreational vehicle, comprising a body, a toilet and a sink, in particular a restroom sink and/or kitchen sink, wherein the toilet and the sink are attached to the body and wherein, in a basic position, the toilet is arranged below the sink.

Furthermore, the object is achieved by a recreational vehicle, in particular a mobile home or a caravan or a van designed as a recreational vehicle, with at least one such piece of furnishing.

The term “van designed as a recreational vehicle” is to be understood in general terms and comprises in particular vehicles that can also be driven in urban areas without much effort, which applies to so-called urban vehicles. This term further comprises recreational vehicles based on box van conversions or so-called campervans. This term also comprises vans suitable for everyday use, so-called urban campers. A preferred scope of application consists of very compact recreational vehicles that can be used not only for camping or other leisure activities, but also in everyday life, for example for shopping. This can improve the utility value of such a recreational vehicle.

On the other hand, such recreational vehicles, in particular very compact recreational vehicles, only have comparatively small interior spaces, so that conventional solutions may not be feasible. The proposed solution, which may be suitably further developed, allows washing, showering, using the toilet and also cooking to be carried out in a very compact manner using one proposed piece of furnishing. This can also be used for recreational vehicles that do not have enough standing height in the interior.

In particular, both toilet use and a shower can be realized.

It is advantageous that the body has a toilet door which can be pivoted horizontally, and that the toilet with the toilet door can be pivoted by at least approximately 90°, preferably up to at least approximately 180° or more. The toilet door is preferably designed as a cupboard door. This allows the toilet to be pivoted out of the body.

Advantageously, the body comprises a ceiling door which can be pivoted horizontally, wherein the sink with the sink door can be pivoted by at least approximately 90°, preferably up to at least approximately 180° or more. This allows the sink with the sink door to be pivoted out of the body. If both the toilet and the sink are pivoted out of the body, then a shower tray can be used if necessary. It is therefore also advantageous that a shower tray is provided which is attached to the body.

It is advantageous that the shower tray can be folded down at least in a position in which the toilet with the toilet door and the sink with the sink door are pivoted out of the basic position by at least approximately 90°. Preferably, the toilet and the sink are pivoted out by more than 90°, in particular by approximately 180°. This allows for comfortable access to the shower tray.

It is also advantageous that the body has a rear wall on which the shower tray can be folded down from the basic position into a shower position about a horizontal hinge axis. This allows the shower tray to be integrated into the body in an advantageous and particularly space-saving manner. This also makes it very comfortable to use. Furthermore, the shower tray does not have to be stored anywhere else in the recreational vehicle.

It is further advantageous that a base area of the shower tray in the shower position is larger than a base area of the body in the basic position. This can further improve comfort when showering.

It is advantageous that the body has a cover which can be opened from the basic position about a horizontal hinge axis. The cover can then be used advantageously. For example, the cover can be used to drain dishes. But the cover can also be used in other ways.

It is advantageous that the cover can be opened from the basic position by at least approximately 180°. This means that the cover can also be used, for example, to place items thereon. It is particularly advantageous that at least one cooking element, in particular an induction cooker, is arranged on the cover, which can be used when the cover is in the opened position. This allows a kitchen to be integrated into the piece of furnishing.

This allows a compact piece of furnishing to be created for a recreational vehicle. The piece of furnishing can also be arranged on a very small area of the floor plan. Even without a permanently enclosed shell and/or without a given standing height, the functions of washing, showering and using the toilet can be carried out at least without significant restrictions.

Further advantages and details of the invention are explained in more detail with reference to the exemplary embodiments shown in the schematic drawings. In the figures:

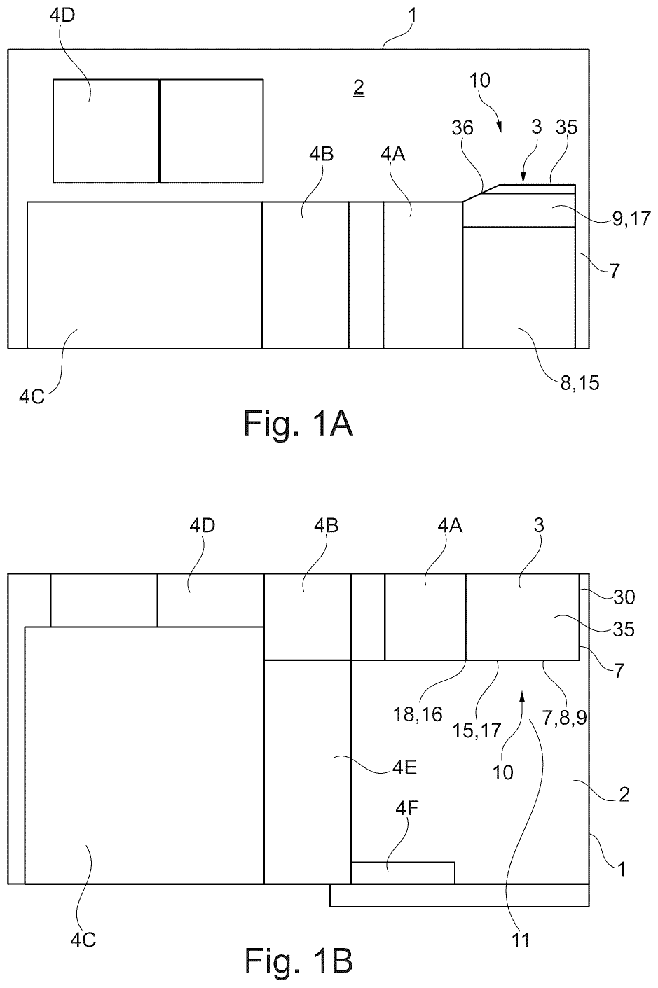

FIG. 1A shows a recreational vehicle 1, wherein an interior in a view transverse to the direction of travel is shown schematically;

FIG. 1B shows the interior shown in FIG. 1A, wherein a floor plan is shown;

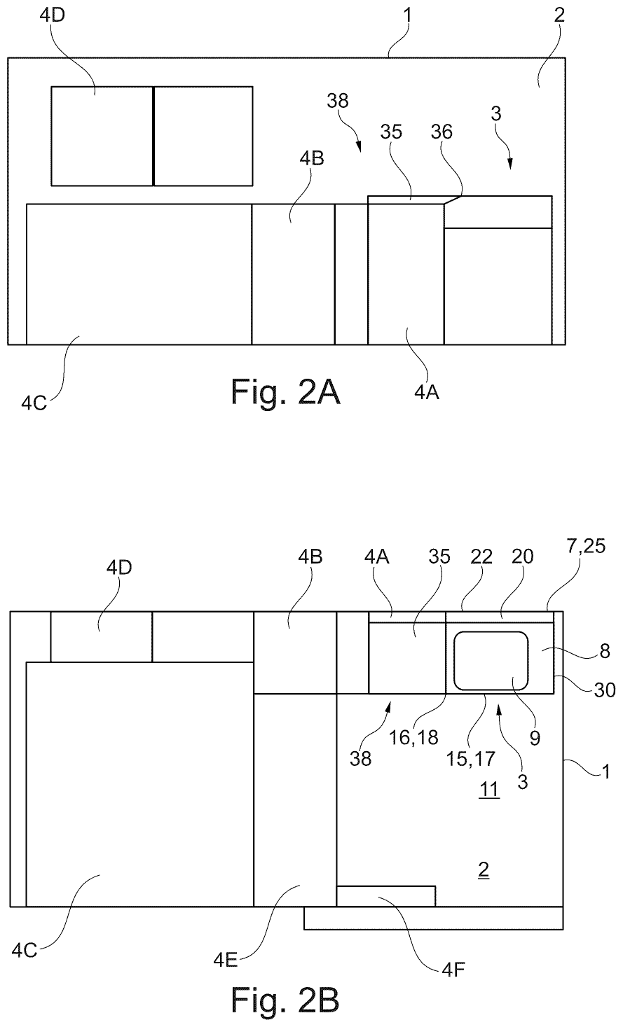

FIG. 2A shows a view corresponding to FIG. 1A, wherein a cover is opened;

FIG. 2B shows the situation shown in FIG. 2B, wherein a floor plan is shown;

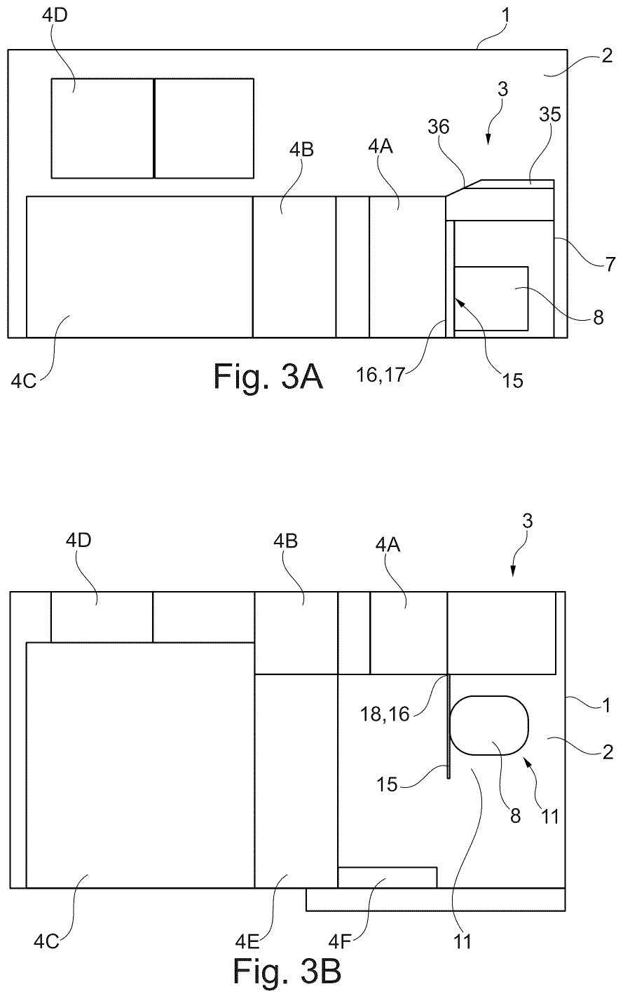

FIG. 3A shows a view corresponding to FIG. 1A, wherein a toilet is pivoted out;

FIG. 3B shows the situation shown in FIG. 3A, wherein a floor plan is shown;

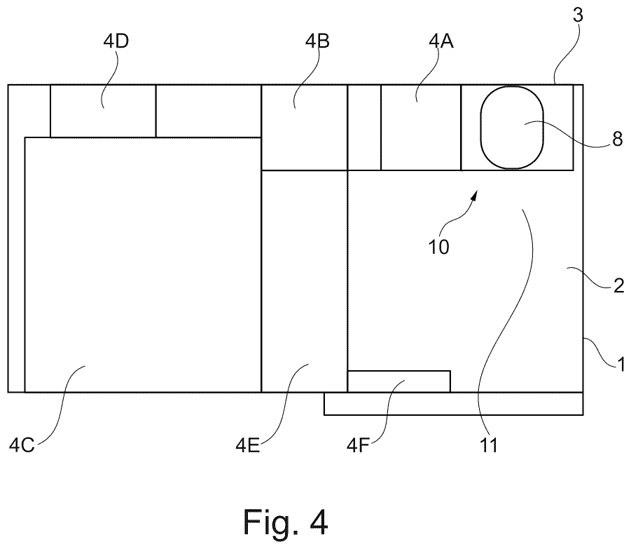

FIG. 4 shows the floor plan shown in FIG. 3B, wherein the position of the toilet in the pivoted-in state is shown;

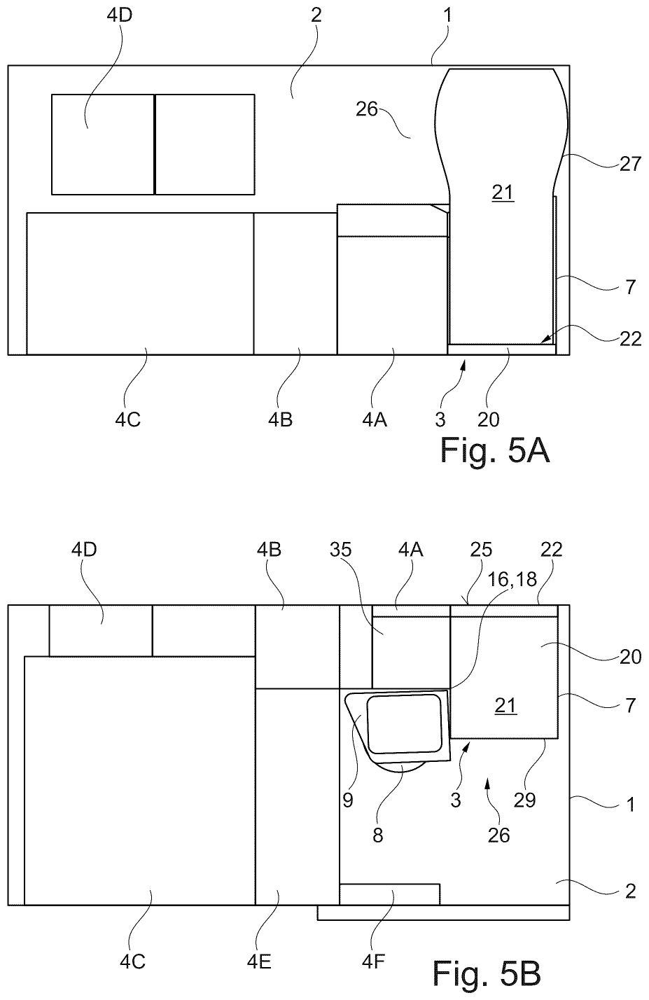

FIG. 5A shows a representation corresponding to FIG. 1A, wherein the function of a shower is realized;

FIG. 5B shows the state shown in FIG. 5A, wherein a floor plan is shown;

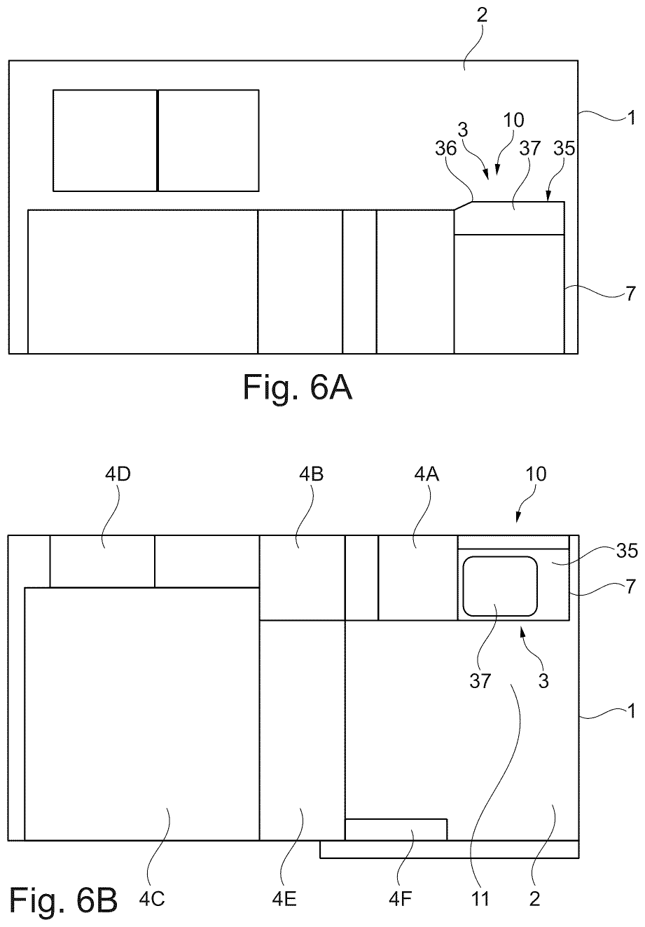

FIG. 6A shows a view corresponding to FIG. 1A according to a modified embodiment, wherein a cooking surface is provided on a cover;

FIG. 6B shows the situation shown in FIG. 6A, wherein a floor plan is shown;

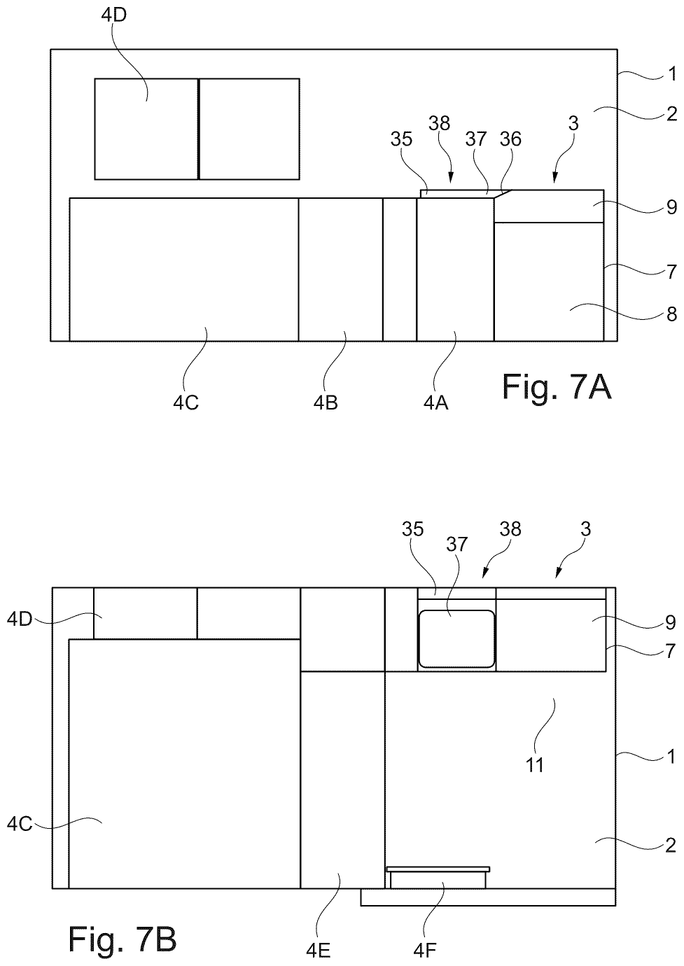

FIG. 7A is a view of the modified embodiment corresponding to FIG. 6A, wherein the cover is opened;

FIG. 7B shows the situation shown in FIG. 7A, wherein a floor plan is shown.

FIG. 1 shows a recreational vehicle 1 according to an embodiment in a schematic representation, wherein an interior 2 is shown transversely to a direction of travel. In the interior space 2, a piece of furnishing 3 is arranged, the design and functioning of which is further described with reference to the drawings. Furthermore, two further pieces of furnishing 4A to 4F can be arranged in the interior 2. Depending on the design, the piece of furnishing 4A may, for example, be another piece of kitchen furnishing.

The furnishing 4B can, for example, be designed as storage cabinets. The piece of furnishing 4B can be designed as a bed. The piece of furnishing 4E can be designed as a bench.

The piece of furnishing 3 has a body 7. The body 7 is not necessarily closed on all sides. Furthermore, the piece of furnishing 3 has a toilet 8 and a sink 9. The sink 9 can be a bathroom sink and/or kitchen sink.

In FIG. 1, a basic position 10 for the piece of furnishing 3 is shown. In the basic position 10, the toilet 8 and the sink 9 are arranged in the body, resulting in a compact arrangement. The toilet 8 is arranged below the sink 9. The toilet 8 and the sink 9 are suitably attached in the body 7. This allows the toilet 8 and the sink 9 to be led out of the body 7. In particular, the toilet 8 and the sink 9 can be pivoted out of the body 7.

FIG. 1B shows the interior 2 of the recreational vehicle 1 in a floor plan view. Here, the compact design of the piece of furnishing 3 is shown in the basic position 10.

FIGS. 2A and 2B show the interior 2 of the recreational vehicle 1, wherein FIG. 2A shows a view corresponding to FIG. 1A, and FIG. 2B shows a view of the floor plan. The piece of furnishing 3 can be used, for example, for personal hygiene. The sink 9 can then serve as a restroom sink 9. By opening a cover 35 arranged on the top of the piece of furnishing 3, as shown in FIG. 1A, the piece of furnishing 3 is opened. The restroom sink 9 underneath can then be used.

FIG. 3A shows a view of the interior 2 of the recreational vehicle 1 corresponding to FIG. 1A. FIG. 3B shows the situation of FIG. 3A, wherein a floor plan is shown. This illustrates a possible use of the toilet 8. For this purpose, the body 7 has a toilet door 15 which can be pivoted horizontally. In this case, a pivot axis 16 can be provided which is vertically oriented when the recreational vehicle 1 is in a horizontal orientation. In this representation, the toilet 8 with the toilet door 15 is pivoted by 90° out of the body 7. This allows the toilet 8 to be used comfortably. Depending on the design, the toilet 8 can also be pivoted out by more than 90°, in particular by up to 180°. In principle, a further pivoting is also conceivable, but in this embodiment this is not possible due to the additional pieces of furnishing 4A, 4B.

In this embodiment, the toilet door 15 is the lower door of the body 7. By opening the toilet door 15, the toilet 8 pivots into the free space 11 in front of the piece of furnishing 3 and can thus be used. The preferred opening angle is between 90° and 180°, depending on the available space (free space) 11.

FIG. 4 illustrates the position of the toilet 8 in the pivoted-in state, i.e., in the basic position 10, within the body 7.

FIGS. 5A and 5B show a situation when showering, wherein FIG. 5A shows a view corresponding to FIG. 1A and FIG. 5B shows a floor plan. To allow for showering, the upper cover of the piece of furnishing 3 is first opened. Furthermore, the body 7 has a sink door 17 which can be pivoted horizontally. Here, a pivot axis 18 is provided, which in this embodiment corresponds to the pivot axis 16. If the recreational vehicle 1 is aligned horizontally, then the pivot axis 18 is oriented vertically. The sink 9 can be pivoted with the sink door 17 by at least 90° and preferably by 180°. The sink 9 can, for example, be designed as a restroom sink 9. The sink 9 is preferably firmly mounted to the sink door 17. Furthermore, the toilet door 15 with the toilet 8 is opened.

The piece of furnishing 3 has a shower tray 20 which serves to realize the shower 21. Preferably, the shower tray 20 is foldable about a horizontal hinge axis 22. In the basic position 10, the shower tray 20 is preferably folded up against a rear wall 25 of the body 7. In the shower position 26, the shower tray 20 is then folded down.

Thus, in the basic position 10, the shower tray 20 can stand vertically on the rear wall 25, wherein the shower tray 20 can be hinged at its bottom.

The shower tray 20 may contain a shower curtain 27 which is firmly and tightly mounted all the way around the inside and which can be pulled out upwards in the next step. Fastening points such as snap fasteners, magnets or hooks may be provided on the shower curtain 27 for hanging, or such fastening points or their counterparts may be arranged in the interior 2.

Fastening points can be arranged at different heights depending on the space available. A shower curtain length of the shower curtain 27 is designed accordingly. By widening the shower curtain 27, as illustrated in FIG. 5A, the available shower space, in particular in the region of the shoulders, can be increased, so that an improved use of space is possible. The widening of the shower curtain 27 can be achieved by cutting the shower curtain fabric and/or by a resilient design of the shower curtain fabric. The enlarged shower space provides greater comfort.

Access to the shower is possible on the front side via an opening 15 in the shower curtain 27. The opening in the shower curtain can be closed tightly after entering using a suitable fastener. Furthermore, there may also be a means of access on the back of the shower curtain 27 to, for example, a shower fitting and the shower hose located there.

A water drainage for the shower tray 20 can be located in the hinge region of the shower tray 20, i.e., in the region of the hinge axis 22. The water drainage can, for example, lead to the waste water system of the recreational vehicle 1 via a flexible pipe, which can ensure safe and tight drainage of the water even when the shower tray 20 is folded upwards after showering.

The base area 29 provided by the shower tray 20 in the shower position 26 can be significantly larger than the base area 30 (FIG. 1B), since at least part of the height of the body 7 can be used for the shower tray 20 folded upwards.

FIGS. 6A and 6B show the recreational vehicle 1 according to a modified design, wherein FIG. 6A shows a view corresponding to FIG. 1A and FIG. 6B shows a floor plan of the interior 2. This illustrates a situation in which the piece of furnishing 3 can also be used for cooking. In this embodiment, the body 7 has a cover 35 on which a cooking element 37 is arranged. The horizontal hinge axis 36 allows for the cover 35 to be opened. As a result, the cooking element 37 can be arranged upside down on the cover 35 in the initial position shown in FIGS. 6A and 6B. In particular an induction cooker is suitable as a cooking element 37. Gas or cartridge stoves are also possible. To use the cooking element 37, the cover 35 is pivoted by 180° about the horizontal hinge axis 36.

FIG. 7A and FIG. 7B show the views corresponding to FIGS. 6A and 6B, wherein the cover 35 is pivoted by 180° so that the cooking element 37 comes into the use position. As described, for example, with reference to FIGS. 2A and 2B, the piece of furnishing 3 can then allow the use of the sink 9, in particular the kitchen sink 9, when the cover 35 is folded down.

This means that even in very compact recreational vehicles 1 with limited spaces, all the functions of an otherwise very large bathroom can be provided. Due to the possibility of additional adaptation to the available space or the free spaces 11 in front of or to the side of the piece of furnishing 3, the piece of furnishing 3 can be very easily adapted to any situation. When choosing the toilet 8, different toilet types are possible, which allows further adaptation to different design examples. The position of the bathroom can be freely chosen within the floor plan of the recreational vehicle 1. Headroom or room height does not represent a restriction either, as it can be used while sitting. Furthermore, the accommodation of at least one cooking element 37 in the piece of furnishing 3 is particularly space-saving, wherein the simple folding out for use allows for a significant improvement in the use of space with a high level of comfort.

The design of the piece of furnishing 3 can be adapted to the corresponding application case. For example, the piece of furnishing 3 can be of modular construction so that individual functional modules, in particular for the toilet 8, the sink 9, the shower tray 20 and/or the cooking element 37, can be retrofitted or replaced.

This means that advantageous adaptations can be made depending on the application case and/or customer requirements.

The invention is not limited to the embodiments described.

1. A piece of furnishing for a recreational vehicle, in particular for a mobile home or a caravan or for a van designed as a recreational vehicle, comprising a body, a toilet and a sink, in particular a restroom sink and/or kitchen sink,
characterized in that
the toilet and the sink are attached to the body and in that, in a basic position, the toilet is arranged below the sink.

2. The piece of furnishing according to claim 1,
characterized in that
the body has a toilet door which can be pivoted horizontally, and in that the toilet (8) with the toilet door can be pivoted by at least approximately 90°, preferably up to at least approximately 180° or more.

3. The piece of furnishing according to claim 1,
characterized in that
the body has a sink door which can be pivoted horizontally, and in that the sink with the sink door can be pivoted by at least approximately 90°, preferably up to at least approximately 180° or more.

4. The piece of furnishing according to claim 1,
characterized in that
a shower tray is provided which is attached to the body.

5. The piece of furnishing according to claim 4,
characterized in that
the shower tray can be folded down at least in a position in which the toilet with the toilet door and the sink with the sink door are each pivoted out of the basic position by at least approximately 90°.

6. The piece of furnishing according to claim 5,
characterized in that
the body has a rear wall on which the shower tray can be folded down from the basic position about a horizontal hinge axis into a shower position.

7. The piece of furnishing according to claim 6,
characterized in that
a base area of the shower tray in the shower position is larger than a base area of the body in the basic position.

8. The piece of furnishing according to claim 1,
characterized in that
the body has a cover which can be opened from the basic position about a horizontal hinge axis.

9. The piece of furnishing according to claim 8,
characterized in that
the cover can be opened from the basic position by at least approximately 180°, and/or at least one cooking element, in particular an induction cooker, is arranged on the cover, which can be used when the cover is in the opened position.

10. A recreational vehicle, in particular a mobile home or caravan or a van designed as a recreational vehicle, comprising at least one piece of furnishing according to claim 1.
